(19) United States
(12) Patent Application Publication
(10) Pub. No.: US 2019/0205400 A1
(43) Pub. Date: Jul. 4, 2019

(54) In Context Document Review and Automated Coding

(71) Applicant: Open Text Holdings, Inc., Wilmington, DE (US)

(72) Inventor: Jan Puzicha, Bonn (DE)

(21) Appl. No.: 15/857,078

(22) Filed: Dec. 28, 2017

(51) Int. Cl. G06F 17/30; H04L 12/58

(52) U.S. Cl. CPC G06F 17/30011; H04L 51/18; G06F 17/301; G06F 17/30126

(57) ABSTRACT

In context document review and automated coding are described herein. An example method includes determining at least one binding between documents, the at least one binding being indicative of a contextual relationship between the documents, selecting a review order for the documents based on the at least one binding, the review order comprising a hierarchical arrangement of the documents, displaying the documents in a graphical user interface based on the review order; and automatically coding the documents based on the at least one binding and control data received through the graphical user interface.

### FIELD OF INVENTION

The present disclosure is directed to electronic discovery, and more particularly, but not by limitation, to systems and methods that provide accelerated and in context document review and automated coding of documents based on document bindings.

### SUMMARY

According to some embodiments, the present disclosure is directed to a method comprising: generating a review order for receiving control data for each document in a group of documents; receiving user input including control data for a first document of the group of documents in the review order; generating a first option to receive control data for a second document of the group of documents in the review order based on the received control data for the first document in the review order; generating a second option to receive control data for the second document in the review order based on separate user input; receiving user input including a selection of the first option or the second option; and receiving control data for the second document based on the received user input option selection.

According to some embodiments, the present disclosure is directed to a method comprising: determining at least one binding between documents, the at least one binding being indicative of a contextual relationship between the documents; selecting a review order for the documents based on the at least one binding, the review order comprising a hierarchical arrangement of the documents; displaying the documents in a graphical user interface based on the review order; and automatically coding the documents based on the at least one binding and control data received through the graphical user interface.

According to some embodiments, the present disclosure is directed to a system comprising: a processor; and a memory for storing executable instructions, the processor executing the instructions to: determine at least one binding between documents, the at least one binding being indicative of a contextual relationship between the documents; select a review order for the documents based on the at least one binding, the review order comprising a hierarchical arrangement of the documents; display the documents in a graphical user interface based on the review order; and automatically code the documents based on the at least one binding and control data received through the graphical user interface.

### BRIEF DESCRIPTION OF THE DRAWINGS

Certain embodiments of the present technology are illustrated by the accompanying figures. It will be understood that the figures are not necessarily to scale and that details not necessary for an understanding of the technology or that render other details difficult to perceive may be omitted. It will be understood that the technology is not necessarily limited to the particular embodiments illustrated herein.

FIG. 1 is flowchart of an example method for practicing aspects of the present disclosure.

FIG. 2 is an example graphical user interface GUI constructed in accordance with the present disclosure.

FIGS. 3 and 4 collectively illustrate documents that have been reviewed which color panels that are changed to a different color based on review and/or coding operations.

FIG. 5 illustrates the GUI of FIGS. 1-3 after review of documents has occurred.

FIGS. 6 and 7 collectively illustrate the review and coding of documents comprising a blind carbon copy, through the GUI.

FIGS. 8 and 9 collectively illustrate the review of near-duplicate documents using the GUI.

FIGS. 10 and 11 collectively illustrate an aspect of reporting to a reviewer that an attachment in one document is identical to an attachment in a previously reviewed document or in a document that is yet to be reviewed.

FIG. 12 is flowchart of another example method for practicing aspects of the present disclosure.

FIG. 13 illustrates an exemplary computing system that may be used to implement embodiments according to the present technology.

### DETAILED DESCRIPTION

Generally described, the present disclosure is directed to systems and methods that allow for in-context and accelerated document review. These systems and methods also provide document coding suggestions based on analysis, as well as automated document coding between documents in a group. In some embodiments, documents are grouped for review based on at least one binding. In general, a binding comprises a relationship between two or more documents. These documents can have the same or differing document type. When one or more bindings are determined, a review order for the documents is established. This review order places the documents in a hierarchical order based on the one or more bindings. In various embodiments, the hierarchical order used to display the document ensures that only a minimum number of documents of the group need to be reviewed prior to automatically coding a remainder of the documents based on the review of a smaller subset.

In some embodiments, the systems and methods herein are configured to present documents in a sequential and hierarchical ordering based on bindings between two or more documents. In various embodiments, a binding type includes a family binding. In general, a family binding is a relationship between two documents that are integrated with one another. For example, an email document is drafted by an author and the author appends one or more attachments within the email. The binding between the email and the attachment is a family binding type.

Another binding type includes an inclusion binding. An inclusion binding is present when one document is wholly included in another document. For example, when forwarding or replying to a first email document generated by a first author, a second author creates a second email document. The first email document is nested, either wholly within the second email in some embodiments. A review of the first email document when a review of the second email document has already occurred creates inefficiencies. The systems and methods disclosed herein are adapted to ensure that documents with inclusion type bindings are not reviewed in an accelerated and efficient manner by preventing duplicative review and allowing for semi- and completely automated coding or tagging of documents based on prior coding/tagging.

The systems and methods herein also allow for special handling of other binding types such as near-duplicate binding or even user-selected sorting orders. These and other advantages of the present disclosure are provided in greater detail below.

In some embodiments, duplicates and near-duplicates are not organized into a review order. Instead duplicates can be coded as part of a first document in a duplicate group, and then are no longer stepped on (e.g. reviewed again) when stepping through the batch. Also, near-duplicates are exploited by showing the coding of a previously coded near-duplicate when stepping through the batch, resulting in a fast operation, but not an automated one. In these instances, a reviewer makes a decision for near-duplicates, and not the system.

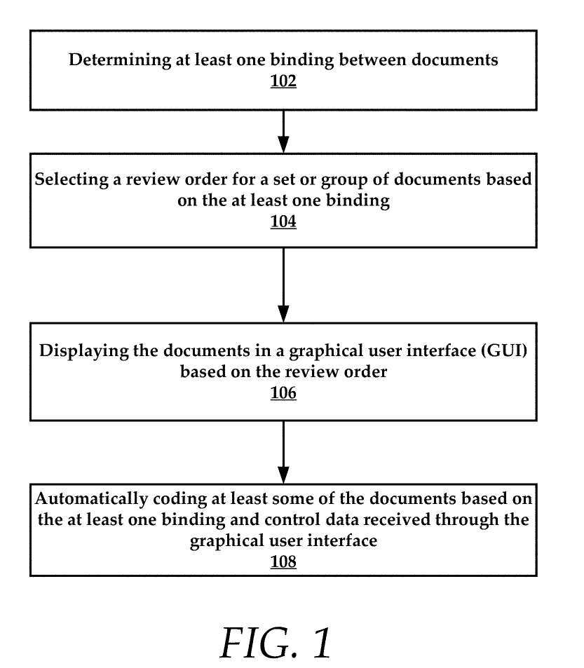

As used herein, a ‘review group’ is made of all documents that are attached, included, and their attachments. In some embodiments, all documents in a review group are jointly coded. That is, the standard workflow of the system takes the user through all documents that are necessary for viewing (original doc, all attachments, all emails that have a bcc). The reviewer then jointly makes a decision after reviewing all the documents in a review group. This process accounts for fact that the designation or coding for a document may be influenced by its attachments, and can not necessarily be made stand-alone manner without consideration of related documents. FIG. 1 is a flowchart of a method for analyzing relationships between documents in a document batch. This method can also include additional features such as automated coding based on the analyzed document relationships.

For context, the system providing the method will receive a batch of documents and review content of each of the documents. The system will review the contents of the documents to determine if the documents have at least one binding type. In some embodiments, the binding type may only exist between a subset of documents in the group. In other embodiments the group is based on the fact that the documents share at least one binding type. For example, a group of email documents is selected based on the fact that they all appear in an email string having a plurality of email documents that are linked by operations such as reply operations. In one example, if an email is transmitted to a plurality of recipients and each of the recipients responds to the email, each of the replies are part of the document group.

As noted above, a family binding between documents includes a document and any related documents associated with the document at the time of its original creation. For example, a family binding exists when an email is created that includes attachments. In sum, a family binding defines a relationship between one of the documents and an attachment, or an inclusion of another document within the document.

In various embodiments, binding types have an ordering. For example, the binding type of family is a higher order binding type than an inclusion binding type. Thus, when a reviewer is presented documents to review in a document batch, the GUI will present any documents with family bindings first for review and coding. Then documents with inclusion bindings will be reviewed and coded, potentially using automated coding.

Other binding types such as near-duplicate binding and user-selected sort order binding can also be present. In one or more embodiments, the order of the bindings includes family, inclusion, near-duplicate, and selected ordering. It will be understood that another binding can include a duplicate binding, for example, duplicates between attachments of non-duplicative families. In eDiscovery, duplicate families are usually removed, but duplicates between attachments of different families are kept.

In some embodiments, the method includes a step 102 of determining at least one binding between documents. It will be understood that the at least one binding is indicative of a contextual relationship between at least two of the documents.

In some embodiments, documents can have more than one binding. For example, three documents, referred to as Document 1, Document 1A, Document 1B, Document 2, and Document 3 are known. The bindings include Document 1 being an initial email in an email chain with Document 2 and Document 3 being intermediate emails created through any of replying or forwarding of Document 1. Document 1A and Document 1B are attachments originally present when Document 1 was created and transmitted. It will be assumed that Document 1, Document 1A, and Document 1B share a binding type of family, whereas Document 1, Document 2, and Document 3 have a binding type of inclusion. In more detail, Document 3 was a last reply that wholly incorporates Document 2 and Document 1, with Document 2 being an intermediate email between Document 1 and Document 3. Because Document 2 and Document 3 are replies to Document 1, may include Documents 1A and 1B unless these documents were removed by the authors of either Document 2 or Document 3 when replying to Document 1. In most instances, when readers reply to or forward emails with attachments, the replied or forwarded email may not include the attachment unless the reader specifically selects to include the attachments. Thus, Documents 1A and 1B still need to be viewed. However, members of the same family have a high likelihood of being coded identically; hence there is still an advantage to code them in context.

In some embodiments, family relationships/bindings are determined when parsing native email formats such as msg, eml or PST—they are not determined from the textual analysis (as it is for inclusion). Content such as attachments in an email are indicative of a family binding as well.

For general discussion, Document 1 is referred to as a root document when referencing the aspect of an inclusion binding type. Document 3 is referred to generally as an end of branch document because it is the last document in a chain of documents. The end of branch document includes, either wholly or in-part, all prior documents in a chain of documents.

Exceptions to these general binding rules will be discussed in greater detail infra.

In light of the above, the method will further comprise a step 104 of selecting a review order for a set or group of documents based on the at least one binding. Using the example above, an example review order would include reviewing Document 3 first, because it comprises all of the contents of both Document 2 and Document 1. In some embodiments, the method includes scanning or analyzing each of the documents in the set for information that is indicative of a binding. This could include document information embedded in the document, such as information that would indicate if an email is a reply or forward email. In other embodiments, the content of each document can be scanned or analyzed and overlapping content can be used as the basis for determining which documents in a group have a family or inclusion binding.

The review order includes a hierarchical arrangement of the documents based on the binding. For example, Document 3 will be reviewed first because it is the end of branch document in the group. As for Document 1, which is included in Document 3 by virtue of Document 1 being included in Document 3, the attachments of Document 1A and Document 1B should be suggested for review prior to automatic or guided coding (e.g., tagging) of each of the Documents.

In some embodiments, a review order for a review group is fixed. For example, an end-of-branch is reviewed first, followed by attachments, followed by an included email, followed by its attachments, and so forth. This is reflective of the principle that ‘family has the higher binding’.

Thus, the method includes a step 106 of displaying the documents in a graphical user interface (GUI) based on the review order. The GUI comprises a plurality of tools that allow the reviewer to review one or more of the documents in the set as well as provide a coding or tagging of the documents as will be described in greater detail infra.

After the reviewer has reviewed each suggested document, such as Document 3, Document 1A, and Document 1B, the reviewer can code any of these documents as desired. Once these documents have been coded, the method can include a step 108 of automatically coding at least some of the documents based on the at least one binding and control data received through the graphical user interface.

In general, the term “control data” refers to the input received from a user that controls not only how a particular document is coded, but also whether the coding of that document can be propagated through other documents having at least one binding in common with that coded document.

Thus, an action taken with respect to a first document in a group can be automatically propagated to other documents in the group based on the control or input received from a reviewer with respect to that first document, assuming that the review order that controls the presentation of the first document is based on the bindings set forth above.

As noted above, there are some special case bindings that are lower in order than family and inclusion. One of these special case bindings involves what is referred to as a near-duplicate binding. A near-duplicate of a document is found when, but for a threshold amount of differences between two or more documents, content of these two or more documents is nearly identical. It will be understood that a near-identical match for a document can occur with respect to other documents in a currently evaluated group of documents, but may also be present when a document being currently reviewed matches or is near-identical to a document that has previously been reviewed and coded. Thus, the systems disclosed herein can maintain a cache or memory of document analyses and determine if a document that is near-identical has already been reviewed. This feature is valuable in instances where many reviewers are reviewing groups of documents, or when reviewers are reviewing documents in batches over an extended period of time. In manual review processes, it is likely that a human reviewer would forget (or would never know) that a document that they are currently reviewing is near-identical to another document that they or another party have already previously coded. This near-identical binding analysis prevents these oversights and inefficiencies, especially when many reviewers are working independently of one another. Additionally, reviewing near-duplicates together again makes the review process more efficient.

In some embodiments, when a near-duplicate is found or detected, the systems and methods can propose or automatically code a first document with a coding of a second document when the document is determined to have a near-duplicate binding relative to the second document.

In various embodiments, prior to automatically coding, the systems and methods can display on the GUI any differences between the first document and the second document. This allows the reviewer to quickly determine if the differences between the first and second documents are substantial enough to warrant separate coding of the documents despite their near-duplicate binding.

In yet other embodiments, the systems and methods herein can execute coding automatically without regard to differences between near-duplicate bindings. That is, the presence of the near-duplicate binding is sufficient to allow for automatic coding.

In some embodiments, the systems and methods disclosed herein are capable of identifying for the reviewer (through the GUI) at least a portion of the documents that do not require review based on the at least one binding. For example, if Document 2 and Document 1 are wholly incorporated into Document 3, Document 2 and Document 1 are not placed in the review order. In other instance, Document 2 and Document 1 can be placed in the review order but can be indicated as not requiring review using, for example, color coding where a hue of gray is used to indicate that these documents do not require review.

In another special use case, if a document, such as an email, is determined to be a blind carbon copy email, or an email in an email chain/thread has been edited, the systems and methods can indicate that these documents require review despite the fact that they may have one or more of the binding types described above. Stated otherwise, the GUI can include a suggestion to review an email document of the email chain/thread even if the email document is wholly incorporated into another email document, if the email document has been determined to have been edited subsequent to it being sent from to a recipient. By way of example, if the author of Document 2 changed some of the textual content in Document 1 before transmitting the email, it may be suggested that both Document 1 and Document 2 need to be reviewed despite the fact that they share an inclusion binding. In some embodiments, the system would no longer consider Document 1 and Document 2 to be included, so they no longer share the binding. This is different for bcc email message, because in this case the documents still have an inclusion binding, but it is recommended to review the included email because of the bcc meta-data properties.

Had Document 1 not been edited during the creation of Document 2, the GUI would have displayed only a suggestion that Document 2 should be reviewed.

With the above embodiments disclosed, the following descriptions are provided to illustrate various embodiments through use of screenshots of a document review GUI.

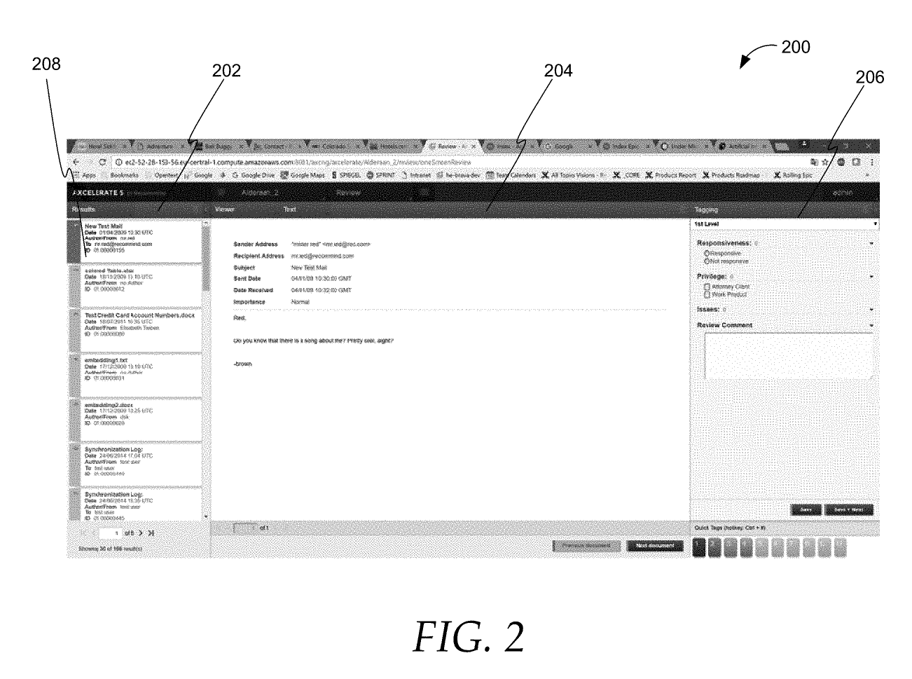

FIG. 2 illustrates an example GUI 200 of the present disclosure. The GUI 200 generally comprises a plurality of panels, such as a first panel 202, a second panel 204, and a third panel 206. In general, the first panel 202 includes representations of documents placed according to their review order. Each of the representations comprising identifying information regarding at least one document. It will be understood that the representations comprise an icon that indicates a document type and a color that is indicative of at least one binding.

The second panel 204 displays the contents of a document selected from the first panel 202. The third panel 206 comprises selectable coding options that can be applied to the document displayed in the second panel. To be sure, selected coding options can be manually or automatically applied to a subsequent document when the subsequent document comprises the at least one binding of the document.

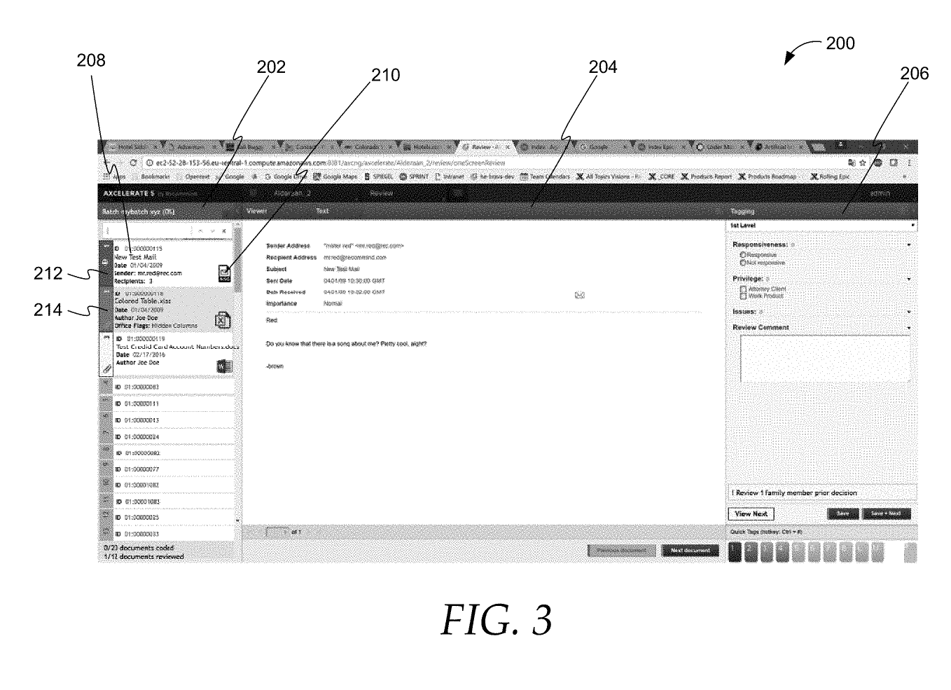

In more detail, the GUI 200 in FIGS. 2 and 3 collectively includes documents, such as Document 1, Document 1A, and Document 1B presented in the first panel 202. Each representation, such as a representation 208 of Document 1, includes a truncated portion of identifying information about the document such as a document title, date, sender, and recipient count. In some embodiments, the representation can comprise an icon 210 that indicates what type of document is referenced by the representation.

A color panel 212 associated with the representation 208 indicates that the document associated therewith requires review. A color panel, such as panel 214, indicates that Document 1A is an attachment with a family binding to Document 1. The representation of Document 1A also indicates that there are special conditions associated with the Document 1A, namely that it includes hidden columns in a spreadsheet. Thus, part of the process of analyzing the documents when comparing content can include identifying special conditions for the document that indicate that content inside the document is hidden or obscured to some degree. Thus, the reviewer should take special care with Document 1A to ensure that all content is reviewed. Without this indication, the likelihood that the reviewer will not notice that columns were hidden is high.

Of note, in the third panel 206, alert messages are presented indicating that the reviewer should review the two family members (Document 1A and Document 1B) prior to deciding if an automatic coding of other documents with an inclusion binding (if any) should be automatically coded similarly to Document 1.

The reviewer can cycle to the next document using a View Next button in the third panel 206.

In general, the reviewer can view all documents in a review group prior to making a coding decision on any particular document.

The first panel 202 also includes various other documents in the group placed underneath Documents 1-1B. These documents also have bindings to Document 1, but are collapsed to allow for the documents having a family binding to be analyzed first. Once documents with family bindings have been reviewed, the system will suggest documents with inclusion bindings. In some embodiments, these additional documents not currently being reviewed are presented in a collapsed state and reference, for example, only a unique identifier for the document In some embodiments, it will be understood that family members and included emails are opened, these are referred to generally as a ‘review group’ and are (re)viewed jointly before making a coding decision. In some embodiments, this coding decision is applied to all of the documents in the review group at the same time.

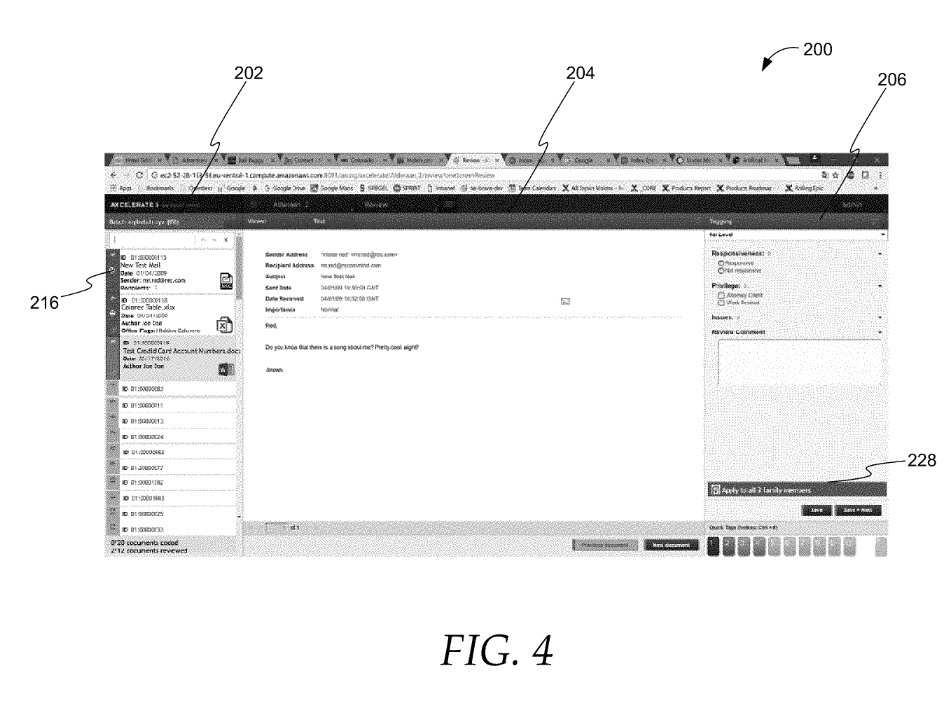

As illustrated in FIGS. 3 and 4, documents that have been reviewed have color panels that are changed to a different color, such as green. A unique icon can be utilized for any document that has been reviewed but not coded, such as icon 216.

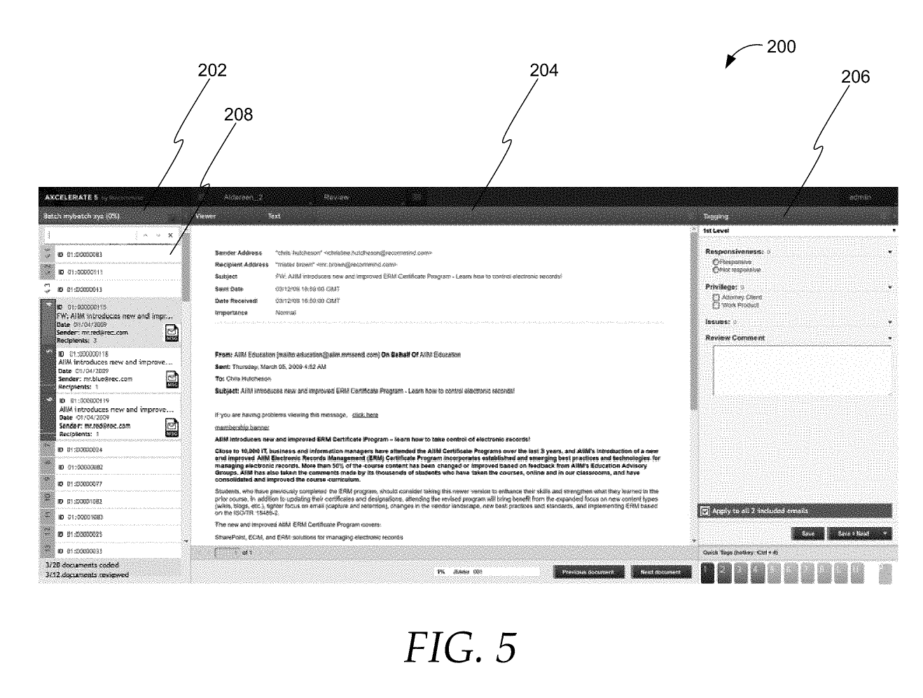

FIG. 5 illustrates the GUI 200 after review of documents. After a document has been reviewed and coded, the document representation, such as representation 208 is collapsed. A blue check mark or other icon can be used to indicate that the document has been reviewed. In other embodiments, a check mark with a color such as orange indicates that the document was coded as “privileged.” Other indicators can be used for what are referred to as hot documents (e.g., documents that are of particular interest). In general, the user can define what coding of a document should be mapped on what color. ‘responsiveness’, ‘privilege’, ‘hot’ are just typical document designations that we expect a user would want to color differently.

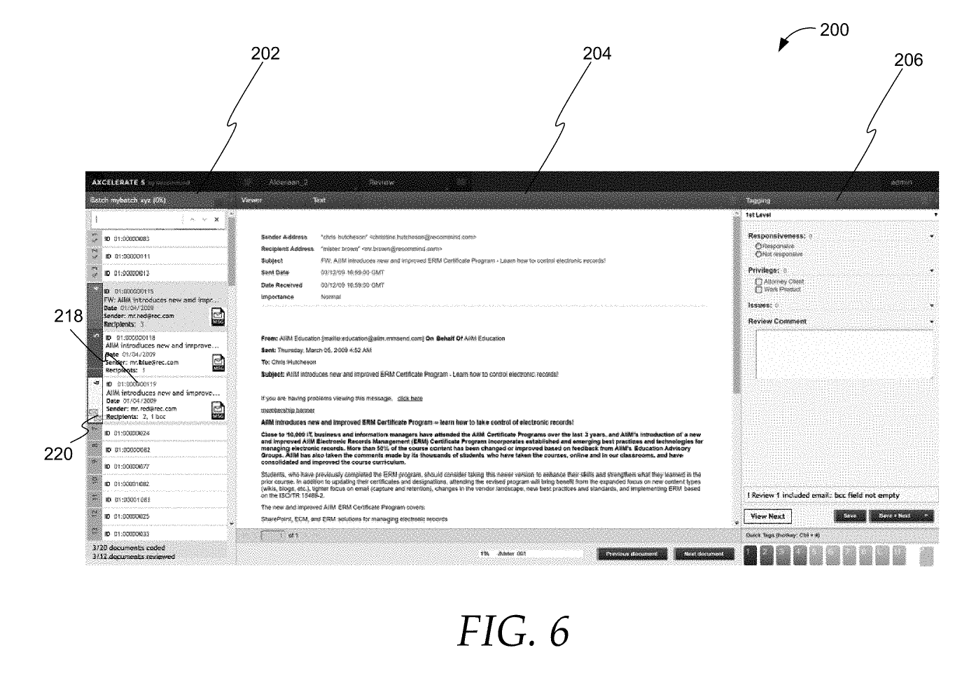

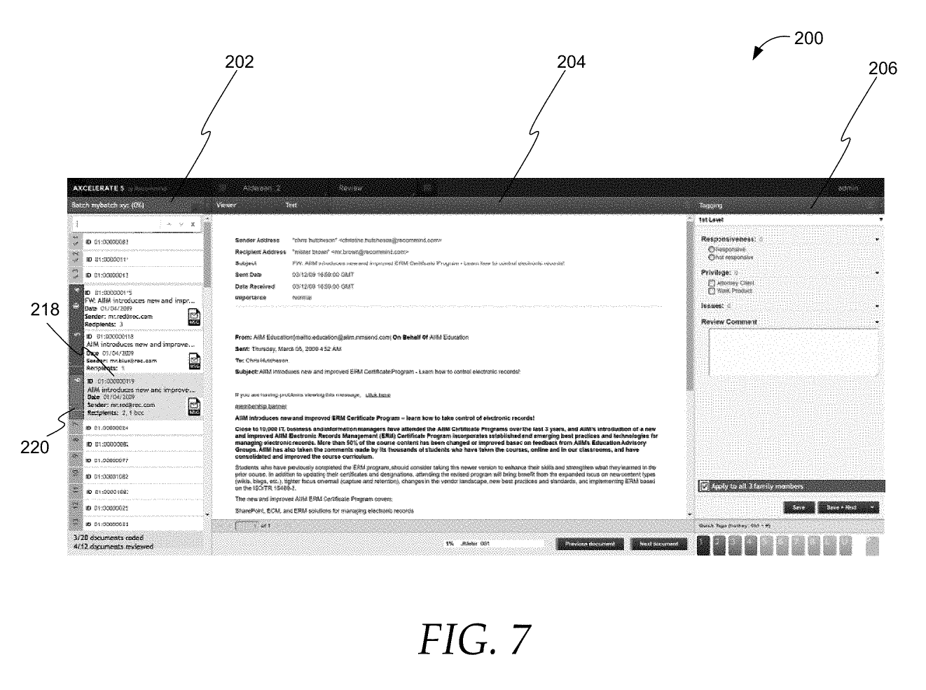

FIGS. 6 and 7 collectively illustrate the review and coding of documents comprising a blind carbon copy through the GUI 200. For example, representation 218 of a blind carbon copy document. The reviewer is alerted to the need to review additional documents along with this particular document by an included emails icon 220. The color panel of the representation 218 will change from one color to a second color when the review of the BCC and associated documents has been undertaken by the reviewer.

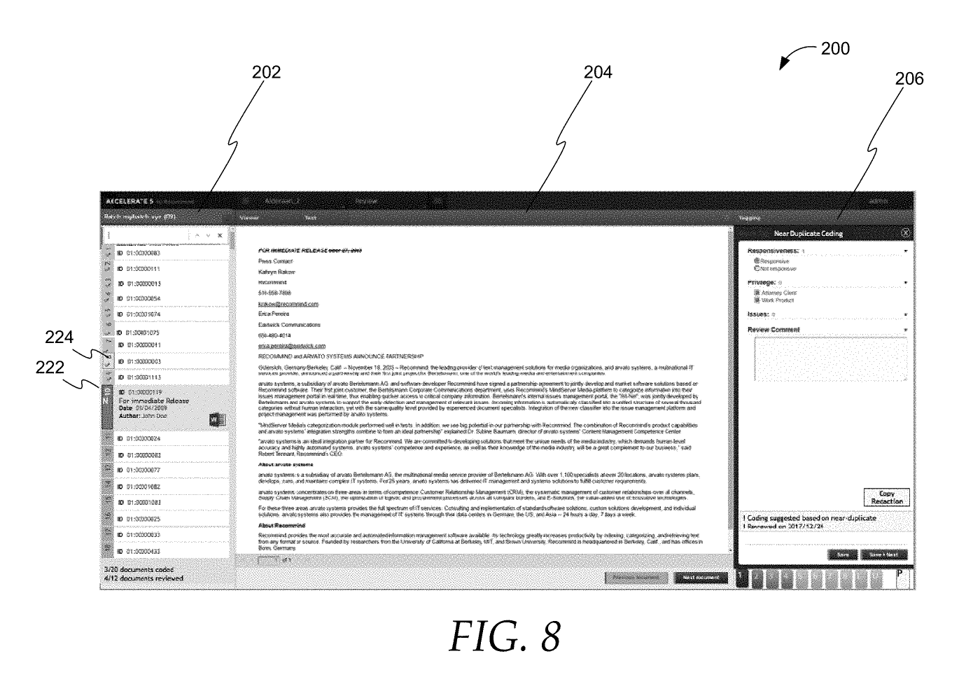

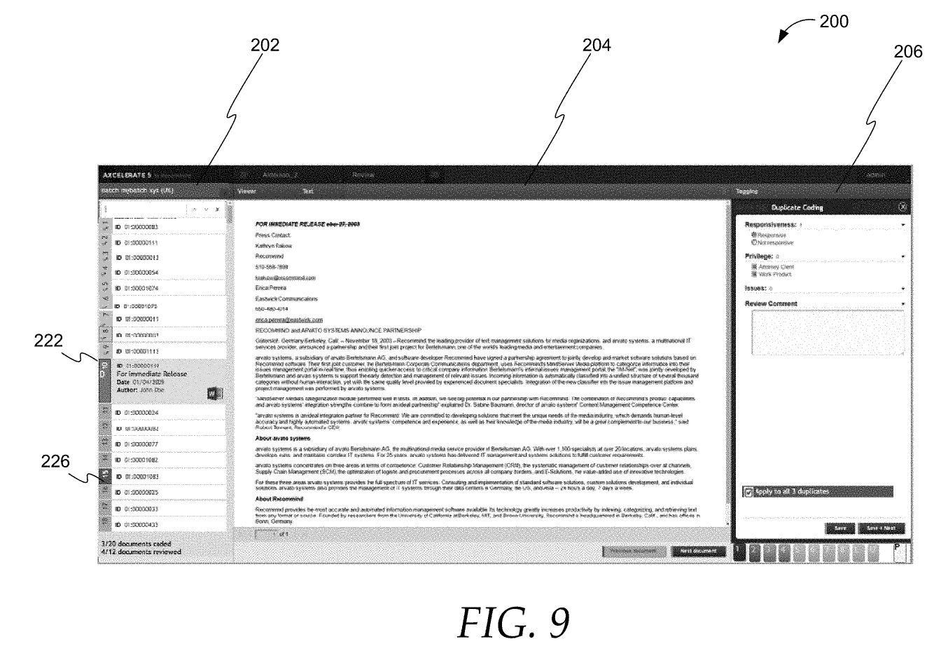

FIGS. 8 and 9 collectively illustrate the review of near-continuous documents using the GUI 200. In some embodiments, a representation 222 of a document includes an “N” or “D” indicating that the document has a near-duplicate. A document having D indication is a duplicate document for which content is identical to another document. These documents will have the same MD5 hash code. The document having near-duplicate content is referred to by representation 224 and indicated with a color panel. In FIG. 9, a subsequent document and its representation 226 are indicated when a consistent duplicate option is being used. Thus, the reviewer can visualize that other document that are yet to be reviewed in the review order are also near-duplicates.

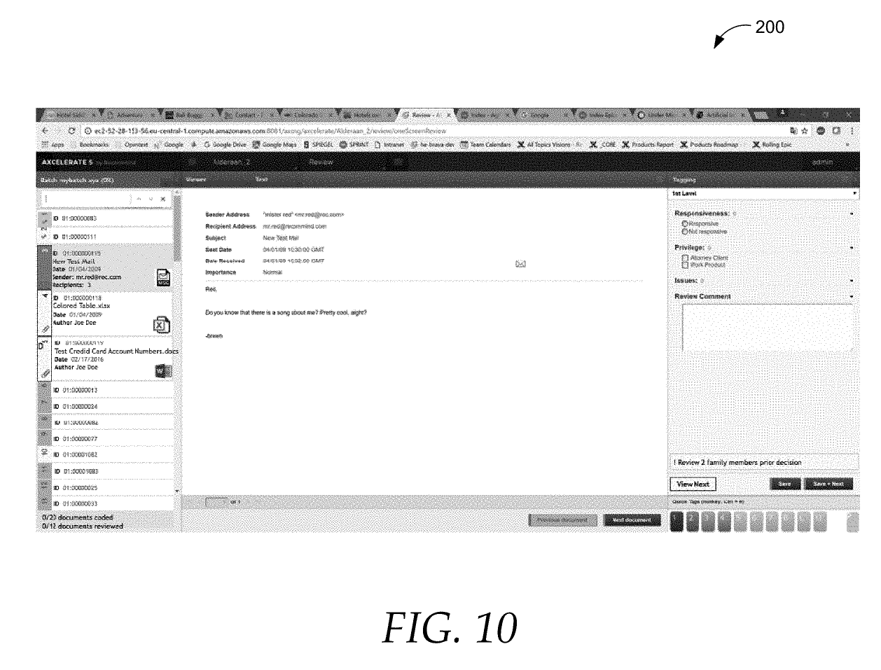

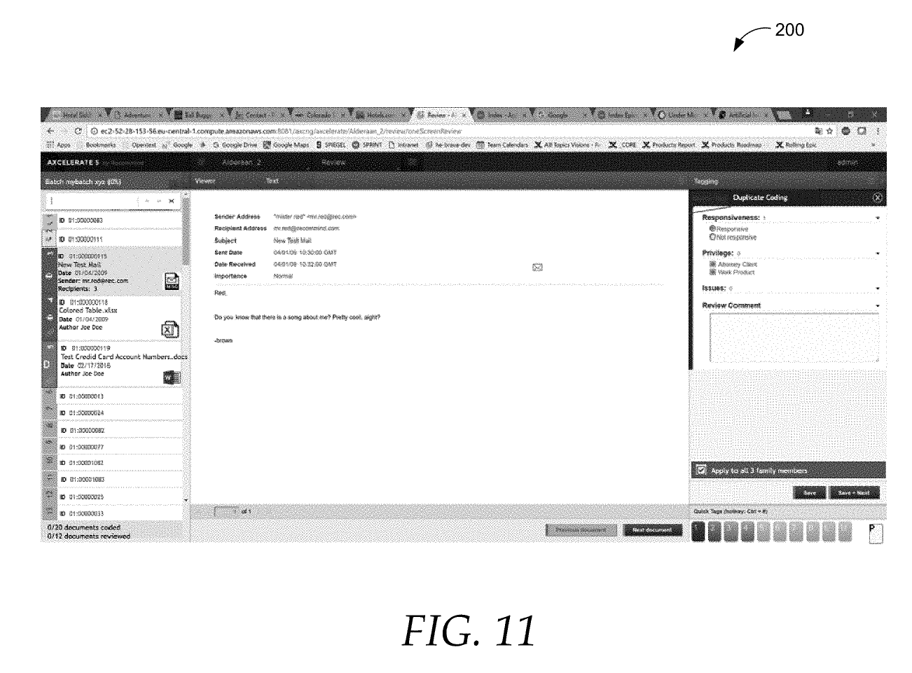

FIGS. 10 and 11 collectively illustrate an aspect of reporting to a reviewer that an attachment in one document is identical to an attachment in a previously reviewed document or in an attachment that is yet to be reviewed (when consistent duplicate option is being used). This methodology is similar to that described above but with respect to attachments rather than document content, such as textual content in an email.

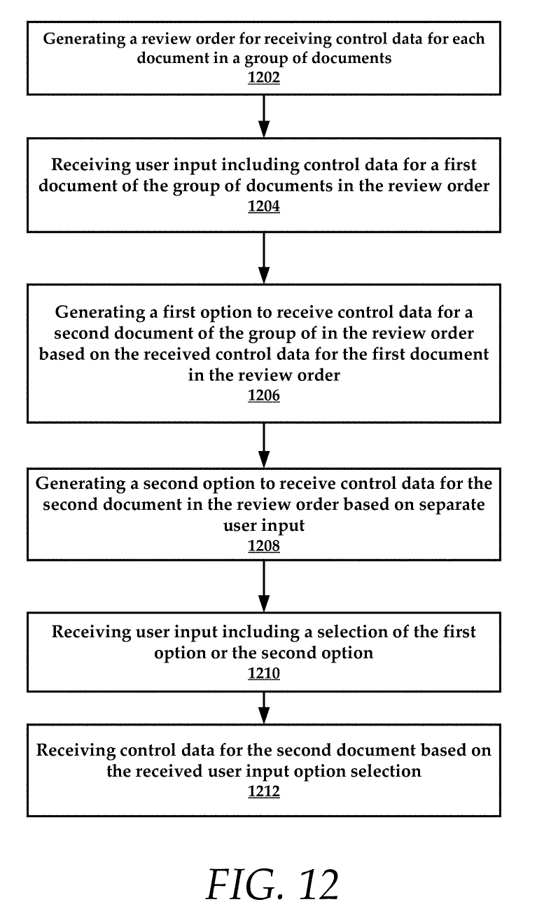

FIG. 12 illustrates another example method of the present disclosure. The method includes a step 1202 of generating a review order for receiving control data for each document in a group of documents. Stated otherwise, the review order for the documents in a group is established according to the embodiments described above. The control data that is received includes the reviewer input used to review and/or code documents in the group.

Thus, the method includes a step 1204 of receiving user input including control data for a first document of the group of documents in the review order. This could include a document with a family binding or an end of branch document where no family bindings are present in the document group.

Next, the method includes a step 1206 of generating a first option to receive control data for a second document of the group of in the review order based on the received control data for the first document in the review order. For example, the reviewer can indicate that this second document is to be coded with the same coding/tagging of a prior document. The method includes a step 1208 of generating a second option to receive control data for the second document in the review order based on separate user input, as well as a step 1210 of receiving user input including a selection of the first option or the second option. In some embodiments, the method includes a step 1212 of receiving control data for the second document based on the received user input option selection.

In some embodiments, an option corresponds to a choice presented to a user on a GUI, such as GUI 200. The user may select the option using a variety of GUI elements, including, but not limited to, a check-box, toggle button, and other appropriate information elements. Referring to FIG. 4, in some instances, a checked-box 228 represents selection of the first option choice, and an unchecked-box represents selection of the second option choice.

In some embodiments, the method can include an optional step of generating a group of documents based on a family of the plurality of documents and the first document in the review order is a root document defining the family.

In one or more embodiments, the first document includes at least one of the other documents in the group of documents. In one example use case the first document includes an email and the second document includes an email and is included in the first email. Moreover, the second document is associated with meta-data. The method can include controlling a review of the second document under the second option based on the meta-data.

In some embodiments, the second document is a near-duplicate of the first document. In these embodiments, the method includes automatically receiving control data for the second document based on the received control data for the first document.

In one or more embodiments where the second document is a near-duplicate of the first document, the method can include receiving user input to set the control data for the second document based on the received control data for the first document.

In yet other embodiments where the second document is a near-duplicate of the first document the method can include receiving user input to set redaction data for the second document based on the redaction data for the first document.

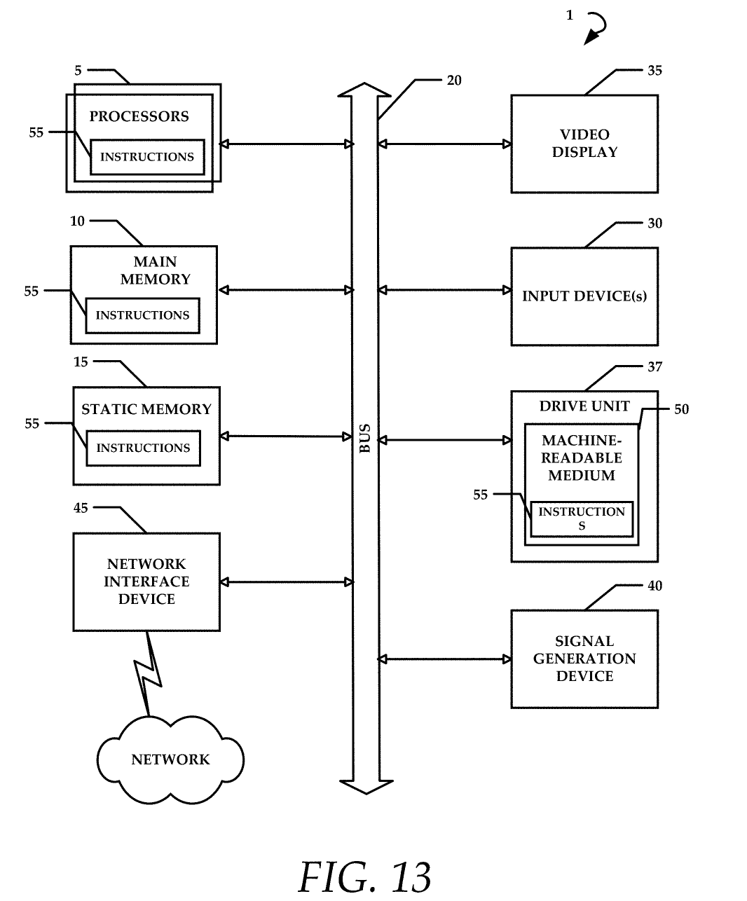

FIG. 13 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a robotic construction marking device, a base station, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1 includes a processor or multiple processors 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processors 5 during execution thereof by the computer system 1. The main memory 10 and the processors 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

Not all components of the computer system 1 are required and thus portions of the computer system 1 can be removed if not needed, such as Input/Output (I/O) devices (e.g., input device(s) 30). One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

As used herein, the term “module” may also refer to any of an application-specific integrated circuit (“ASIC”), an electronic circuit, a processor (shared, dedicated, or group) that executes one or more software or firmware programs, a combinational logic circuit, and/or other suitable components that provide the described functionality.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present. The description herein is illustrative and not restrictive. Many variations of the technology will become apparent to those of skill in the art upon review of this disclosure.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A method of analyzing documents comprising:
generating a review order for receiving control data for each document in a group of documents;
receiving user input including control data for a first document of the group of documents in the review order;
generating a first option to receive control data for a second document of the group of documents in the review order based on the received control data for the first document in the review order;
generating a second option to receive control data for the second document in the review order based on separate user input;
receiving user input including a selection of the first option or the second option; and
receiving control data for the second document based on the received user input option selection.

2. The method according to claim 1, wherein generating a group of documents is based on a binding of the group of documents and the first document in the review order is a root document defining the binding.

3. The method according to claim 2, wherein the binding comprises any of:
a family binding defining a relationship between one of the documents and an attachment of the document;
an inclusion binding comprising the second document of the documents being wholly included in the first document of the documents;
a near-duplicate binding; and
a user-selected ordering.

4. The method according to claim 2, wherein the first document includes at least one of the other documents in the group of documents.

5. The method according to claim 4, wherein the first document includes an email and the second document includes an email and is included in the first document.

6. The method according to claim 2, wherein the second document is associated with meta-data, further comprising controlling a review of the second document under the second option based on the meta-data.

7. The method according to claim 1, wherein the second document is a near-duplicate of the first document, further comprising automatically receiving control data for the second document based on the received control data for the first document.

8. The method according to claim 1, wherein the second document is a near-duplicate of the first document, further comprising receiving user input to set the control data for the second document based on the received control data for the first document.

9. The method according to claim 1, wherein the second document is a near-duplicate of the first document, further comprising receiving user input to set redaction data for the second document based on the redaction data for the first document.

10. The method according to claim 1, further comprising receiving a plurality of documents via a computing device.

11. A method, comprising:
determining at least one binding between documents, the at least one binding being indicative of a contextual relationship between the documents;
selecting a review order for the documents based on the at least one binding, the review order comprising a hierarchical arrangement of the documents;
displaying the documents in a graphical user interface based on the review order; and
automatically coding the documents based on the at least one binding and control data received through the graphical user interface.

12. The method according to claim 11, wherein the at least one binding comprises any of:
a family binding defining a relationship between one of the documents and an attachment of the document;
an inclusion binding comprising a first document of the documents being wholly included in a second document of the documents;
a near-duplicate binding; and
a user-selected ordering.

13. The method according to claim 12, further comprising indicating, on the graphical user interface, at least a portion of the documents that require review based on the at least one binding.

14. The method according to claim 12, further comprising indicating at least a portion of the documents that do not require review based on the at least one binding.

15. The method according to claim 12, further comprising coding the first document with a coding of the second document when the first document is determined to have the near-duplicate binding relative to the second document.

16. The method according to claim 15, further comprising prior to coding, displaying differences between the first document and the second document.

17. The method according to claim 16, wherein the coding is executed automatically without regard to the differences.

18. The method according to claim 15, wherein when a document of the documents is a blind carbon copy, the document is selected for review without regard to the at least one binding.

19. The method according to claim 11, wherein when the at least one binding comprises an inclusion binding, the method further comprises suggesting review of an email document of the documents even if the email document is wholly incorporated into another email document, if the email document has been determined to have been edited subsequent to it being sent from to a recipient.

20. The method according to claim 11, wherein displaying the documents comprises:
providing a first panel where representations of the documents are placed according to the review order, each of the representations comprising identifying information regarding at least one document, wherein the representations comprise an icon that indicates a document type and a color that is indicative of the at least one binding;
a second panel displaying contents of a document selected from the first panel; and
a third panel that comprises coding options that can be applied to the document displayed in the second panel, wherein selected coding options are automatically applied to a subsequent document when the subsequent document comprises the at least one binding of the document.
